(19) United States
(12) Patent Application Publication
(10) Pub. No.: US 2023/0256676 A1
(43) Pub. Date: Aug. 17, 2023

(54) Apparatus and Method for Three-Dimensional Printing without Human Intervention

(71) Applicant: Peter Liquan Zhou, Bellevue, WA (US)

(72) Inventor: Peter Liquan Zhou, Bellevue, WA (US)

(21) Appl. No.: 17/671,633

(22) Filed: Feb. 15, 2022

(51) Int. Cl. B29C 64/379; B29C 64/10; B33Y 10/00; B33Y 30/00; B33Y 40/00; B33Y 50/00

(52) U.S. Cl. CPC B29C 64/379; B29C 64/10; B33Y 10/00; B33Y 30/00; B33Y 40/00; B33Y 50/00

(57) ABSTRACT

According to embodiments of the disclosed subject matter in this application, a three-dimensional (“3D”) printer with a printhead, scraping mechanism and a printer bed is disclosed. When instructed, the 3D printer starts printing a 3D object on the printer bed. Once the 3D printer completes printing the 3D object, the scraping mechanism removes the 3D object out of the printer bed so that the 3D printer may start printing a new 3D object without human intervention.

### BACKGROUND

### 1. Field

Embodiments of the invention relate generally to three-dimensional (“3D”) printing and, more specifically, to apparatuses and methods for printing multiple 3D objects without human intervention.

### 2. Description

3D printing is also called additive manufacturing. It is a process of constructing a 3D object from a digital 3D model by slicing the digital 3D model into many thin layers and laying down successive layers of materials until the 3D object is constructed. An apparatus that performs 3D printing is called a 3D printer. Various types of materials may be used for 3D printing, such as plastic powders, plastic filaments, and metal powder grains. 3D printers used to allow only one material to be printed at a time. Nowadays most 3D printers can perform 3D printing with multiple materials. A typical 3D printer includes a printhead, a printer bed, a printer base, and a printer frame. The printhead receives print material and deposits the print material on the printer bed layer by layer. The print bed holds an object to be printed and may be able to move vertically as the height of the object changes. The printer frame hosts the printhead and the print bed. The printer base is normally at the bottom of a 3D printer and hosts a control center for the 3D printer.

A 3D printer is typically slower than a two-dimensional (“2D”) printer because a 3D printer manufactures a 3D object. When a 3D object is completed, the object needs to be removed from the printer bed, normally by a human operator, before a new 3D object can be printed. For example, when a 3D printer completes printing a 3D object in the middle of night, the 3D object may need to wait until the next morning to be removed from the printer bed by a human operator so that the 3D printer can start a new printing job. It would be more efficient and desirable for a 3D printer to print multiple 3D objects without human intervention between objects.

### BRIEF DESCRIPTION OF THE DRAWINGS

The features and advantages of the disclosed subject matter will become apparent from the following detailed description of the subject matter in which:

FIG. 1 shows one example 3D printer according to one embodiment of the disclosed subject matter;

FIG. 2 shows one example gantry in a 3D printer according to one embodiment of the disclosed subject matter;

FIG. 3 shows one example printhead in a 3D printer according to one embodiment of the disclosed subject matter;

FIGS. 3A, 3B, 3C, 3D show different side views of the example printhead shown in FIG. 3;

FIG. 4 shows one example printer bed in a 3D printer according to one embodiment of the disclosed subject matter;

FIG. 4A shows a different view of the printer bed shown in FIG. 4;

FIG. 4B shows an enlarged bed arm shown in FIG. 4;

FIG. 5 shows one example scraping mechanism in a 3D printer according to one embodiment of the disclosed subject matter;

FIG. 6 shows one example scraping mechanism and one example printer bed putting together in a 3D printer according to one embodiment of the disclosed subject matter;

FIG. 7 shows a top view of one example 3D printer according to one embodiment of the disclosed subject matter; and

FIG. 8 shows one example flowchart for printing a 3D object by a 3D printer according to one embodiment of the disclosed subject matter.

### DETAILED DESCRIPTION

According to embodiments of the disclosed subject matter in this application, a 3D printer with a printhead, scraping mechanism and a printer bed is disclosed. When instructed, the 3D printer starts printing a 3D object on the printer bed. Once the 3D printer completes printing the 3D object, the scraping mechanism removes the 3D object out of the printer bed so that the 3D printer may start printing a new 3D object without human intervention.

Reference in the specification to “one embodiment” or “an embodiment” of the disclosed subject matter means that a particular feature, structure, or characteristic described in connection with the embodiment is included in at least one embodiment of the disclosed subject matter. Thus, the appearances of the phrase “in one embodiment” appearing in various places throughout the specification are not necessarily all referring to the same embodiment.

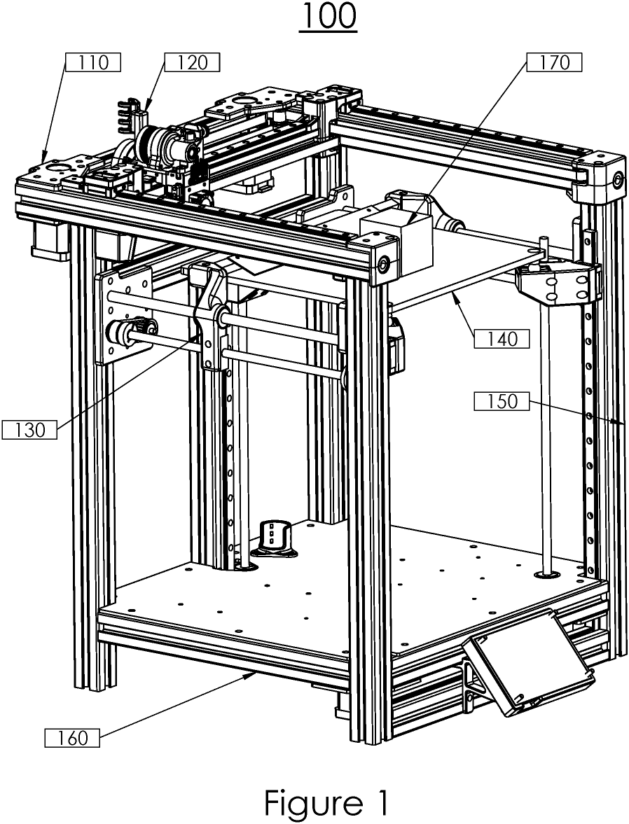

FIG. 1 shows one example 3D printer 100 according to one embodiment of the disclosed subject matter. 3D printer 100 comprises a gantry 110, a printhead 120, scraping mechanism 130, a printer bed 140, a printer frame 150, and a printer base 160. Gantry 110 hosts printhead 120 and other mechanisms which help move printhead 120 horizontally (e.g., along an X axis and/or a Y axis). Printhead 120 receives print material and deposits the print material on printer bed 140 according to instructions received from a control center. Printer bed 140 holds a 3D object 170 to be printed and may move vertically (e.g., along a Z axis) as the height of the 3D object changes. The horizontal move of printhead 120 and the vertical move of printer bed 140 make it possible to print a 3D object. Printer frame 150 may include multiple vertical pillars (e.g., four pillars at the corners of 3D printer 100) and horizontal bars connecting between vertical pillars at the lower part of the vertical pillars. Gantry 110 is installed on the top of printer frame 150. Printer bed 140 may be installed on rails coupled to vertical bars in printer frame 150. Printer bed 140 moves along the rails vertically according to instructions received from a control center. Scraping mechanism 130 is coupled to printer frame 150 and may include two scraper arms, a scraper blade, and moving mechanisms. Once 3D printer 100 completes printing a 3D object, scraping mechanism 130 moves the scraper blade along printer bed 140 to remove the 3D object out of printer bed 140. In one embodiment, scraping mechanism 130 may be fixed on a certain position along vertical pillars of printer frame 150 (e.g., a position close to gantry 110). Printer bed 140 moves vertically toward scraping mechanism 130 once the 3D printer completes printing a 3D object so that scraping mechanism 130 removes the 3D object out of printer bed 140. In another embodiment, scraping mechanism 130 may move toward printer bed 140, once a 3D object is completed, to remove the completed 3D object out of printer bed 140. Once a completed 3D object is removed out of printer bed 140, the 3D printer may start printing a new 3D object. Scraping mechanism 130 enables the 3D printer to print non-stop until the print material runs out. In other words, with scraping mechanism 130 the 3D printer does not need to stop and wait until a completed 3D object is removed out of printer bed 140 by a human operator to start a new printing job. Printer base 160 is located near the bottom of printer frame 150 and may host a control center to store instructions which, when executed, control the move of printhead 120 and printer bed 140.

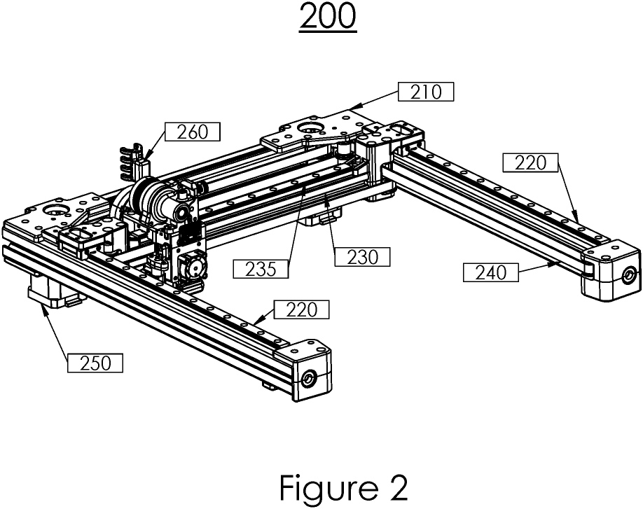

FIG. 2 shows one example gantry 200 according to one embodiment of the disclosed subject matter. Gantry 200 has a “U” shape frame 210 to which linear rail 220, printhead holder 230, moving belt 240, and motor 250 are attached. Printhead 260 is coupled to printhead holder 230 and may move along a linear rail 235 coupled to the printhead holder 230. Printhead holder 230 may move along linear rail 220. Motor 250 drives belt 240 to move printhead 260 along an X axis and/or a Y axis. There are two motors located near the two corners of the gantry. Gantry 200 is a core-xy system, allowing both motors that drive x and y axis to be placed in the back and thus reducing the overall moving weight of the gantry system. Unlike conventional 3D printer gantry systems, both motors are stationary allowing for a lighter weight distribution along x axis and faster printing speed.

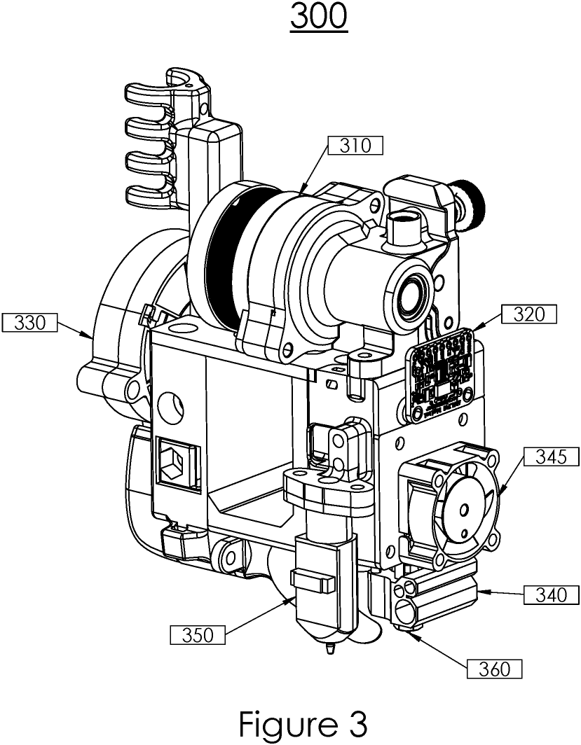

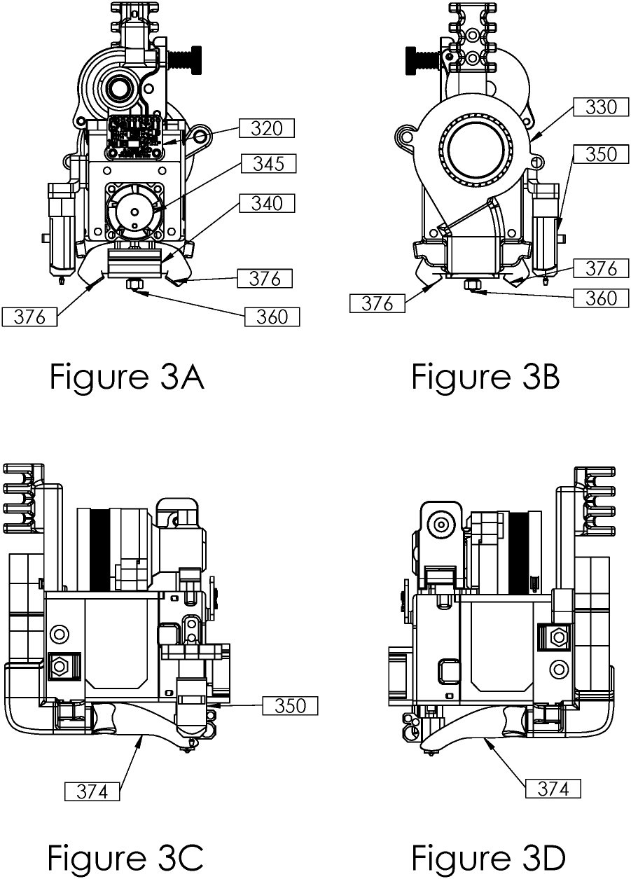

FIG. 3 shows one example printhead 300 according to one embodiment of the disclosed subject matter. Printhead 300 may comprise extruder 310, accelerometer 320, part cooling fan 330, hot end 340, hot end fan 345, bed leveling sensor 350, and nozzle 360. Extruder 310 feeds print material (e.g., plastic filament) down into hot end 340 which heats or melts the print material and further pushes the print material through nozzle 360 to lay down on a printer bed. Extruder 310 may be directly placed above hot end 340 to reduce the distance which the print material has to travel between extruder 310 and hot end 340. Short traveling distance of the print material from extruder 310 to hot end 340 helps reduce retraction and stringing of some types of print material such as plastic filaments and thus helps make printing process smoother. Part cooling fan 330 has a duct (not shown) that directs air flow to both sides of nozzle 360 to cool printed part quickly so that the printed part can retain its rigidity resulting in better overhangs and bridges. Accelerometer 320 works with printer firmware to reduce vibrations from the printer during fast prints. Bed leveling sensor 350 detects if the printer bed is level. If not, bed leveling sensor 350 will work with a 3-point bed leveling system and a control center of the 3D printer to maintain a level bed surface. Hot end fan 345 cools the print material before reaching hot end 340 to ensure smooth passing of the print material from extruder 310 to hot end 340 and thus smooth operation of the printhead.

FIGS. 3A-D show different side views of printhead 300. FIG. 3A shows the front view of hot end 340, hot end fan 345, and accelerometer 320. FIG. 3A also shows two end openings 376 of the part cooling fan duct, each located at one side of nozzle 360. FIG. 3B shows the front view of part cooling fan 330 and shows the part cooling fan duct and its two end openings 376 more clearly than does FIG. 3. FIG. 3C shows the side of printhead 300 where bed leveling sensor is located. FIG. 3D shows the side of printhead 300 which is opposite to the side shown in FIG. 3C. FIG. 3C and FIG. 3D show two side branches 374 of the part cooling fan duct more clearly than does FIG. 3.

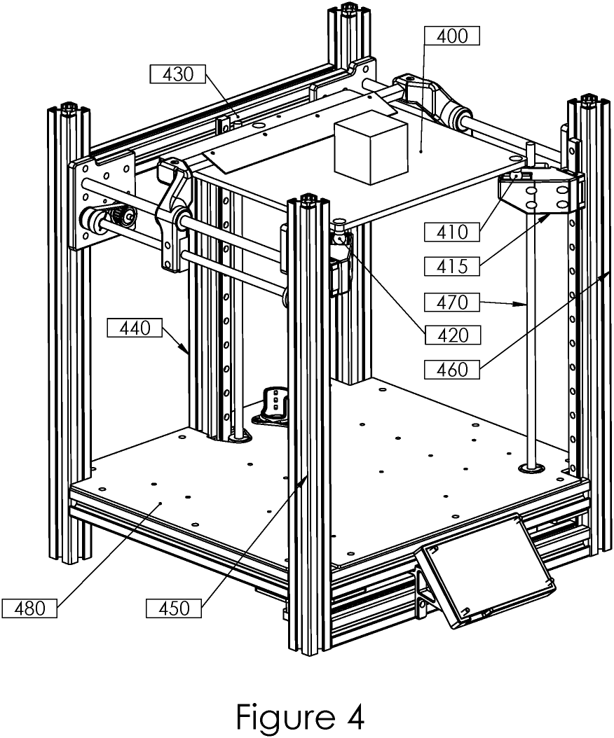

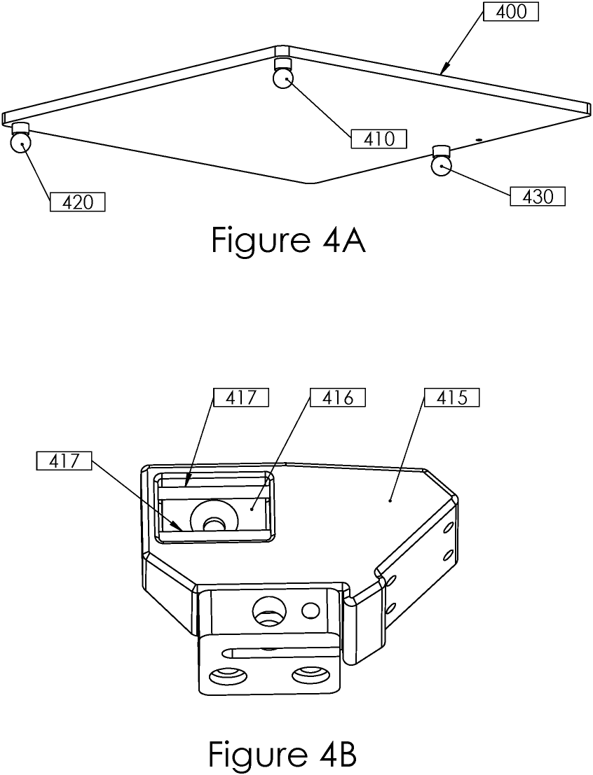

FIG. 4 shows one example printer bed 400 in a 3D printer according to one embodiment of the disclosed subject matter. Main functions of printer bed are to receive print material from a nozzle and to hold a 3D object to be printed. In a typical 3D printer, it is desirable to maintain a printer bed level. Printer bed 400 is supported by a three-point bed leveling system. Support points 410 and 420 of the three-point bed leveling system is shown in the figure. Support point 430 of the three-point bed leveling system is not clearly shown and is blocked by the printer bed itself. Support point 430 is coupled to vertical pillar 440; support point 420 is coupled to vertical pillar 450 and support point 410 is coupled to vertical pillar 460. Each support point includes a ball which may be made of metal (e.g., steel) or other materials. The ball rests on a bed arm which may be moved up and down through a bed leadscrew by a motor in printer base 480. For example, support point 410 rests on bed arm 415 which may be moved up and down through a bed leadscrew 470 by a motor (in printer base 480 and not visible). Bed arm 415 may be coupled to bed leadscrew 470 through a bed leadscrew nut (not shown in FIG. 4) so that when bed leadscrew 470 rotates it drives bed arm 415 up or down through the bed leadscrew nut. Although terms leadscrew and leadscrew nut are used here and other portions of this disclosure, they are not limited to any physical screw or nut and can be any mechanism or components which, when working together, drive a bed arm move up or down.

FIG. 4A shows a different view of printer bed 400 in FIG. 4. In this figure, all the three support points 410, 420, and 430 are clearly shown, each including a ball which may be made of metal (e.g., steel) or other materials. FIG. 4B shows an enlarged bed arm 415 in FIG. 4. Bed arm 415 includes a recess area 416 which includes two rods 417. Rods 417 may be made of metal (e.g., steel) or other materials. Recess area 416 receives the ball of a support point (e.g., 410). Two rods 417 guard the ball so that a support point will not be easily decoupled from recess area 416. The bottom of recess area 416 may include a magnet to increase coupling between the ball of a support point and the recess area.

The height of each bed arm (e.g., 415) is separately adjustable through a bed leadscrew (e.g., 470). A 3D printer is able to adjust the height of each of three bed arms individually to make its printer bed level. The 3D printer may first detect whether its printer bed is level through a bed leveling sensor (e.g., 350 shown in FIG. 3). If the printer bed is not level, the 3D printer may adjust the height of one or more bed arms to make the printer bed level.

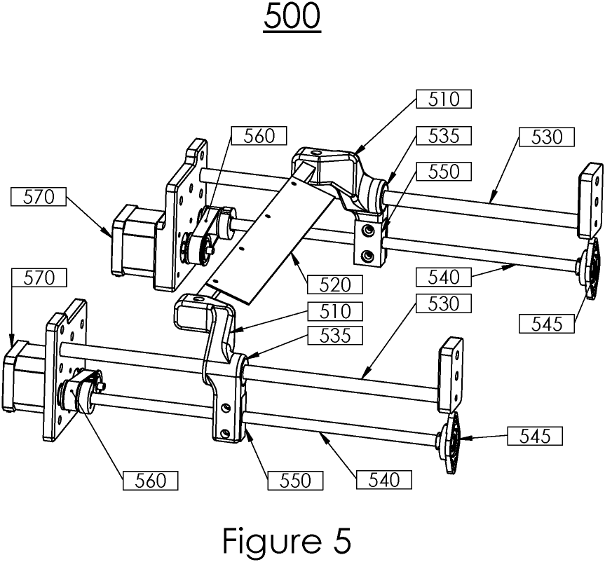

FIG. 5 shows one example scraping mechanism 500 in a 3D printer according to one embodiment of the disclosed subject matter. Scraping mechanism 500 comprises a pair of scraper arms 510, a scraper blade 520, a pair of linear rods 530, a pair of scraper leadscrews 540, a pair of driving mechanism 560, and a pair of scraper motors 570. Scraper blade 520 is installed into the pair of scraper arms 510 as shown in FIG. 5. Each scraper arm is held by a linear rod 530 and connected to a scraper leadscrew 540 through a scraper leadscrew nut 550. Each scraper motor 570 moves driving mechanism 560 which further rotates a scraper leadscrew 540. Driving mechanism 560 may include a pulley and belt which couples a scraper motor and a scraper leadscrew together. In one embodiment, there may be only one motor that drives both driving mechanisms. In another embodiment, they may be a pair of motors, each driving one driving mechanism (as shown in FIG. 5). In another embodiment, there may be only one motor moving only one driving mechanism which drives both scraper leadscrews. In another embodiment, there may be one motor driving a pair of driving mechanisms each driving one scraper leadscrew. Yet in another embodiment (as shown in FIG. 5), there may be a pair of motors each moving one driving mechanism which drives one scraper leadscrew. When there are two motors, two motors are synchronized.

The scraper blade 520 rests in a default position most of time so that it does not interrupt any printing process. In one embodiment, the default position is close to the end where the driving mechanisms 560 are located. In another embodiment, the default position may be somewhere else. When the pair of scraper leadscrews 540 rotate, they move the pair of scraper leadscrew nuts (550) and thus the pair of scraper arms (510). Bearings 545 are mounted at both ends of a scraper leadscrew to allow the leadscrew to rotate smoothly. When the scraper arms (510) move, they slide on the pair of linear rods (530). Each linear rod has a linear bearing 535 to allow for stable and smooth movement. Once the 3D printer completes printing a 3D object, a printer bed moves toward scraping mechanism 500. The printer bed stops at a position so that the edge of scraper blade 520 is very close to or even touches the top surface of the printer bed. The edge of scraper blade 520 is parallel to the surface of the printer bed. Subsequently scraper blade 520 is driven by the scraper leadscrews to remove the completed 3D object out of the printer bed. Once the completed 3D object is out of the printer bed, the scraper blade will return to its default position.

Although terms leadscrew and leadscrew nut are used here and other portions of this disclosure, they are not limited to any physical screw or nut and can be any mechanism or components which, when working together, move scraper blade 520 back or forth.

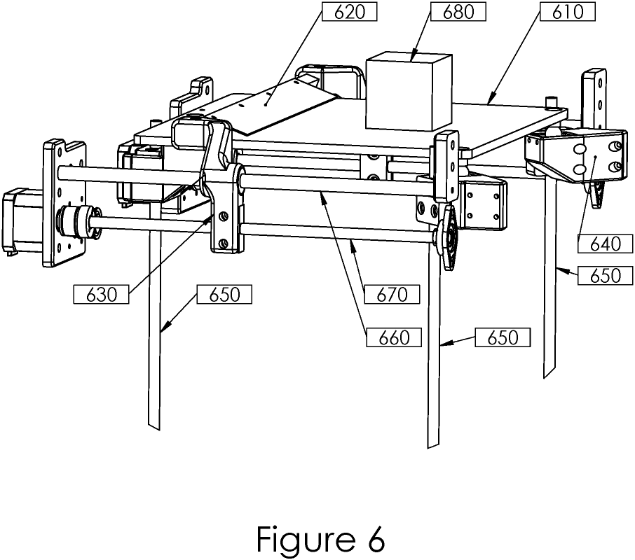

FIG. 6 shows one example scraping mechanism and one example printer bed putting together in a 3D printer according to one embodiment of the disclosed subject matter. This figure shows that a 3D object 680 is completed and printer bed 610 moves up by three bed leadscrews 650 connected to three bed arms 640 through three bed arm nuts. Scraper blade 620 removes the completed 3D object 680 out of printer bed 610. The scraper blade is driven by scraper leadscrews 670 (only one is shown) through scraper leadscrew nuts, which are connected to scraper arms 630. Scraper arms 630 moves along a pair of linear rods 660 (only one is shown).

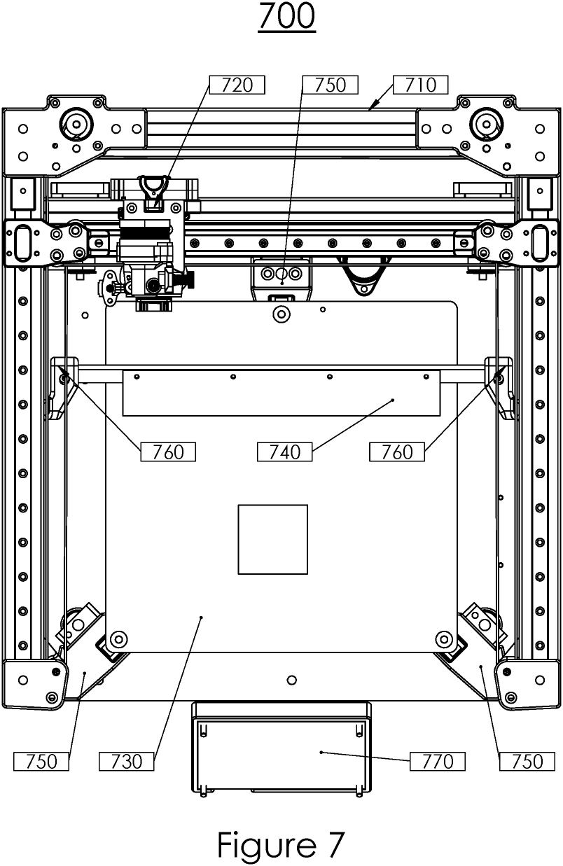

FIG. 7 shows a top view of one example 3D printer 700 according to one embodiment of the disclosed subject matter. From this view, gantry 710, printhead 720, printer bed 730, scraper blade 740, three bed arms 750, two scraper arms 760, and control board 770 can be seen. Control board 770 is connected to printer base and hosts buttons for people to operate the 3D printer 700.

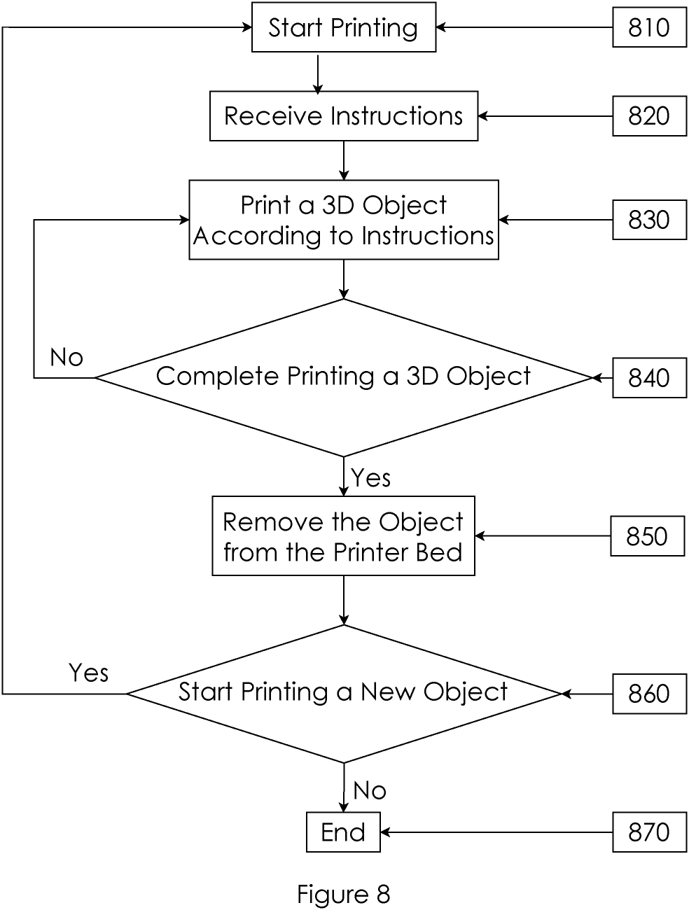

FIG. 8 shows one example flowchart for printing a 3D object by a 3D printer according to one embodiment of the disclosed subject matter. Once a new task of printing a 3D object is started at step 810, the 3D printer may receive instructions at step 820 from a computer connected to the 3D printer via wire or wirelessly. In one embodiment, printing instructions may be stored within the 3D printer (e.g., in a storage associated with a control center in a printer base) and executed by the control center of the 3D printer. At step 830 the 3D printer performs necessary actions to print the 3D object. Typically, the printhead of the 3D printer deposits the first layer of the 3D object onto a printer bed and a subsequent layer on top of the previous layer according to the instructions received. If it is determined that the 3D object has not been completed at step 840, the 3D object continues being printed at step 830; otherwise, the completed 3D object is removed out of the printer bed at step 850. If it is determined that the 3D printer needs to start a new task at step 860, a new 3D object may be started being printed from Step 810; otherwise, the printing process may end at step 870.

Although example embodiments of the disclosed subject matter are described with reference to illustrative and flow diagrams in FIGS. 1-8, persons of ordinary skill in the art will readily appreciate that many other methods of implementing the disclosed subject matter may alternatively be used. For example, the order of execution of the blocks in the flow diagram may be changed, and/or some of the blocks in block/flow diagrams described may be changed, eliminated, divided, or combined.

In the preceding description, various aspects of the disclosed subject matter have been described. For purposes of explanation, specific numbers, systems, and configurations were set forth to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus for printing a three-dimensional (“3D”) object, comprising:
a printer bed to hold the 3D object; and
scraping mechanism to automatically remove the 3D object out of the printer bed once the 3D object is completed.

2. The apparatus of claim 1 further comprises a printhead to deposit a first layer of print material on the printer bed and to deposit a subsequent layer of print material on top of a previous layer.

3. The apparatus of claim 2, wherein the printhead is capable of moving in two horizontal directions.

4. The apparatus of claim 1, wherein the printer bed is coupled to a supporting system through three arms with the height of each arm separately adjustable.

5. The apparatus of claim 1, wherein the scraping mechanism comprises:
a scraper blade with the edge of the scraper blade parallel to the surface of the printer bed; and
two scraper arms connected to the scraper blade at two ends of the scraper blade.

6. The apparatus of claim 5, wherein each of the two scraper arms is coupled to a scraper leadscrew through a scraper leadscrew nut, rotation of two scraper leadscrews driving the scraper blade via two scraper leadscrew nuts to move.

7. The apparatus of claim 5, wherein the scraper blade rests in a position to avoid interrupting the process of printing the 3D object.

8. The apparatus of claim 1 is capable of printing a new 3D object as soon as the completed 3D object is removed out of the printer bed.

9. A three-dimensional (“3D”) printer, comprising:
a printhead to output print material to form a 3D object;
a printer bed to hold the 3D object; and
scraping mechanism to remove the 3D object out of the printer bed, once the 3D object is completed, to enable the 3D printer to start printing a new 3D object without human intervention.

10. The 3D printer of claim 9, wherein the printhead deposits the first layer of the print material onto the printer bed and a subsequent layer of print material on top of a previous layer, the printhead capable of moving in two horizontal directions.

11. The 3D printer of claim 9, wherein the printer bed is capable of moving vertically driven by three bed leadscrews, each of the three bed leadscrews being coupled to a bed arm through a bed leadscrew nut.

12. The 3D printer of claim 11, wherein the printer bed is coupled to three bed arms through three points, height of each of the three bed arms separably adjustable to enable the printer bed to maintain a level position.

13. The 3D printer of claim 12 further comprises a printer bed leveling sensor to sense whether the printer bed is in the level position; and if not, to enable the 3D printer to individually adjust the height of each of the three bed arms to make the printer bed return to the level position.

14. The 3D printer of claim 9, wherein the scraping mechanism comprises a scraper blade with the edge of the scraper blade parallel to the surface of the printer bed; wherein the scraper blade stays in a position, while the 3D printer is printing, to avoid interrupting the 3D printer from printing the 3D object.

15. The 3D printer of claim 14, wherein the scraping mechanism further comprises two scraper arms connected to the scraper blade at two ends of the scraper blade, each of the two scraper arms coupled to a scraper leadscrew through a scraper leadscrew nut, the two scraper leadscrews rotating to lead the scraper blade to move through the two scraper leadscrew nuts.

16. The 3D printer of claim 14, wherein the printer bed moves toward the scraping mechanism once the 3D object is completed so that the scraper blade is in close proximity to the surface of the printer bed to enable the scraper blade to remove the completed 3D object out of the printer bed.

17. A method of printing a 3D object, comprising:
receiving instructions to print the 3D object;
printing the 3D object according to the received instructions; and
once the 3D object is completed, automatically removing the completed 3D object to enable the 3D printer to start printing a new object without human intervention.

18. The method of claim 17 further comprises preparing the 3D printer for printing a 3D object, said preparing including adjust a printer bed of the 3D printer to a level position.

19. The method of claim 17, wherein the instructions include instructions to print the 3D object layer by layer.

20. The method of claim 17 further comprises receiving instructions to print the new 3D object without human intervention.
